(19) United States
(12) Patent Application Publication
(10) Pub. No.: US 2016/0004476 A1
(43) Pub. Date: Jan. 7, 2016

(54) THIN PROVISIONING OF VIRTUAL STORAGE SYSTEM

(71) Applicant: HITACHI, LTD., Tokyo (JP)

(72) Inventor: Hironori EMARU, Santa Clara, CA (US)

(21) Appl. No.: 14/770,577

(22) PCT Filed: Jul. 3, 2013
(86) PCT No.: PCT/US13/49211

§ 371 Date: Aug. 26, 2015

(51) Int. Cl. G06F 3/06; G06F 13/10; G06F 12/08

(52) U.S. Cl. CPC G06F 3/0653; G06F 12/0802; G06F 3/061; G06F 3/067; G06F 13/102; G06F 2212/152

(57) ABSTRACT

Exemplary embodiments of the invention are directed to the effective utilization of storage resources. In accordance with one aspect, a first computer comprises: a memory; and a processor being operable to manage a virtual storage system, formed by one or more physical storage systems, to be provided to a plurality of second computers, the virtual storage system including a plurality of virtual volumes and a plurality of other types of virtual elements. The processor is operable to monitor performance of the plurality of virtual volumes, and to calculate amounts of the plurality of other types of virtual elements to be additionally assigned to the virtual storage system, based on the monitored performance of the plurality of virtual volumes, during operation of the one or more physical storage systems involving accesses from the plurality of second computers to the virtual storage system.

### BACKGROUND OF THE INVENTION

The present invention relates generally to storage systems and, more particularly, to thin provisioning of virtual storage systems.

Virtualization technology is widely used to avoid physical constraint. In the field of the storage, storage system virtualization technique emerges in addition to capacity virtualization technique such as thin provisioning. Currently, virtual storage system technique consists of following features: (a) to avoid constraint of physical storage system, virtual storage system is configured from physical storage system(s); (b) volumes are created from virtual storage system; and (c) created volumes are assigned to the operating systems or applications. One problem with the current technique is that one cannot over provision on physical storage system. In addition, the current solution does not consider the constraint and connectivity of the physical storage systems. Therefore, it is difficult to use resources such as port and cache effectively.

In U.S. Pat. No. 7,441,095, a first storage controller has a multilayer memory hierarchy constructed by LDEV (logical device) connected from LUN, and VDEV (virtual device) connected to the lower order of the LDEV. At least one of the VDEVs is constructed by mapping the memory resources arranged in external storage controllers. The functions of a stripe, RAID, etc. can be added in the mapping. Various kinds of functions (remote copy, variable volume function, etc.) applicable to the normal internal volume can be also used in a virtual internal volume by using the external memory resource as the virtual internal memory resource so that the degree of freedom of utilization is raised.

In U.S. Pat. No. 6,658,478, a data storage system includes a plurality of nodes for providing access to a data storage facility. Each node has a computer-memory complex to provide general purpose computing for the node, a node controller to control data transfers through the respective node, and a cluster memory to buffer data for the data transfers. A plurality of communication paths interconnect the nodes, with a separate communication path provided for each two nodes of the data storage system.

In U.S. Pat. No. 8,356,147, a system comprises a first storage system including a first storage controller, which receives input/output commands from host computers and provides first storage volumes to the host computers; and a second storage system including a second storage controller which receives input/output commands from host computers and provides second storage volumes to the host computers. A first data storing region of one of the first storage volumes is allocated from a first pool by the first storage controller. A second data storing region of another one of the first storage volumes is allocated from a second pool by the first storage controller. A third data storing region of one of the second storage volumes is allocated from the first pool by the second storage controller. A fourth data storing region of another one of the second storage volumes is allocated from the second pool by the second storage controller.

In the three references above, there is no disclosure of the features of this invention including, for example, the over provision on physical storage system even if virtual storage system is configured, and the use of storage resources such as port and cache effectively by considering the constraint and connectivity of the physical storage systems.

### BRIEF SUMMARY OF THE INVENTION

Exemplary embodiments of the invention provide a way to utilize storage resources effectively, including the over provision on physical storage system even if virtual storage system is configured and the use of storage resources such as port and cache effectively by considering the constraint and connectivity of the physical storage systems. Design of virtual storage system is bothersome. When the administrator creates the virtual storage system, he/she has to perform capacity design or performance design after having been conscious of the array group and cache/physical port connectivity.

According to embodiments of this invention, resources such as array group are virtualized to be managed. If only the capacity is short at the time of resource addition, capacity of array group with the reachability is assigned. If the performance is short in addition to the capacity's being short at the time of resource addition, port and cache in addition to array group are assigned. When the cache is assigned, cache partitioning configuration is also executed. As for the cache, it is difficult to manage by capacity because all the capacity may be depleted. Therefore cache is managed by hit rate or some kind of metrics. This realizes the virtual storage system that is not conscious of physical configuration. Combination of this technique and history data managed by the performance monitoring software realizes the thin provisioning of virtual storage system. As a result, it is possible to decrease the cost of executing applications, especially in the cloud environment. The management program provides the recommended plan to decrease the cost.

In accordance with an aspect of the present invention, a first computer comprises: a memory; and a processor being operable to manage a virtual storage system, formed by one or more physical storage systems, to be provided to a plurality of second computers, the virtual storage system including a plurality of virtual volumes and a plurality of other types of virtual elements. The processor is operable to monitor performance of the plurality of virtual volumes, and to calculate amounts of the plurality of other types of virtual elements to be additionally assigned to the virtual storage system, based on the monitored performance of the plurality of virtual volumes, during operation of the one or more physical storage systems involving accesses from the plurality of second computers to the virtual storage system.

In some embodiments, the plurality of other types of virtual elements comprise at least one of virtual port, virtual cache, or virtual storage area. For virtual port, the processor is operable to calculate an amount of virtual port to be additionally assigned to the virtual storage system when a bandwidth of the virtual port exceeds a preset bandwidth threshold based on the monitored performance. For virtual cache, the processor is operable to calculate an amount of virtual cache to be additionally assigned to the virtual storage system when a cache hit ratio of the virtual port exceeds a preset cache hit ratio threshold based on the monitored performance. For virtual storage area, the processor is operable to calculate an amount of virtual storage area to be additionally assigned to the virtual storage system when a capacity of the virtual storage area exceeds a preset capacity threshold based on the monitored performance.

In specific embodiments, the processor is operable to create a virtual storage table showing, for each virtual volume, amounts of the other types of virtual elements assigned, amounts of the other types of virtual elements used, storage pool identification of a storage pool, physical storage resources which are configured and physical storage resources which are provisioned in the storage pool to provide the other types of virtual elements to the virtual storage system. The virtual storage table is used to calculate the amounts of the plurality of other types of virtual elements to be additionally assigned to the virtual storage system. The virtual storage system is formed by one physical storage system, and physical storage resources are provisioned from one storage pool corresponding to the one physical storage system.

In some embodiments, the virtual storage system is formed by a plurality of physical storage systems. Physical storage resources are provisioned from a plurality of storage pools corresponding to the plurality of physical storage systems. The virtual storage table is used to identify, for a given virtual volume, the corresponding storage pool from which storage resources are to be used to provide the calculated amounts of the plurality of other types of virtual elements to be additionally assigned to the virtual storage system.

In accordance with another aspect of the invention, a system comprises: a plurality of second computers; a plurality of physical storage systems; and a first computer which includes a memory and a processor being operable to manage a virtual storage system, formed by one or more physical storage systems of the plurality of physical storage systems, to be provided to the plurality of second computers, the virtual storage system including a plurality of virtual volumes and a plurality of other types of virtual elements. The processor is operable to monitor performance of the plurality of virtual volumes, and to perform thin provisioning of the plurality of other types of virtual elements to the virtual storage system, based on the monitored performance of the plurality of virtual volumes, during operation of the one or more physical storage systems involving accesses from the plurality of second computers to the virtual storage system.

In some embodiments, performing thin provisioning comprises calculating amounts of the plurality of other types of virtual elements to be additionally assigned to the virtual storage system.

Another aspect of this invention is directed to a non-transitory computer-readable storage medium storing a plurality of instructions for controlling a data processor to manage a virtual storage system, formed by one or more physical storage systems, to be provided to a plurality of computers, the virtual storage system including a plurality of virtual volumes and a plurality of other types of virtual elements. The plurality of instructions comprise: instructions that cause the data processor to monitor performance of the plurality of virtual volumes, and to calculate amounts of the plurality of other types of virtual elements to be additionally assigned to the virtual storage system, based on the monitored performance of the plurality of virtual volumes, during operation of the one or more physical storage systems involving accesses from the plurality of second computers to the virtual storage system.

These and other features and advantages of the present invention will become apparent to those of ordinary skill in the art in view of the following detailed description of the specific embodiments.

### BRIEF DESCRIPTION OF THE DRAWINGS

FIG. 1 illustrates an example of a hardware configuration of a system in which the method and apparatus of the invention may be applied.

FIG. 2 shows a logical configuration of the system of FIG. 1.

FIG. 3 shows an example of the virtual storage system.

FIG. 4 shows an example of the physical storage system.

FIG. 5 shows an example of the management server in the system of FIG. 1.

FIG. 6 shows an example of the catalog table.

FIG. 7 shows an example of the media template table.

FIG. 8 shows an example of the application table.

FIG. 9 shows an example of the physical storage table.

FIG. 10 shows an example of the virtual storage table according to the first embodiment.

FIG. 11 shows an example of the performance history table.

FIG. 12 shows an example of a Provisioning GUI of the self-service portal.

FIG. 13 shows an example of a confirmation GUI of the self-service portal.

FIG. 14 shows an example of a flow diagram illustrating a process of the management program of the management server.

FIG. 15 shows an example of a flow diagram illustrating a process to create a plan under step 14060 of FIG. 14 by the management program of the management server.

FIG. 16 shows an example of the virtual storage table according to the second embodiment.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium including non-transitory medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for thin provisioning of virtual storage systems.

### Embodiment 1

The first embodiment discloses how the management program realizes thin provisioning of the virtual storage system. The management program monitors the infrastructure, and if it discovers the resource shortage of the volume, it creates the plan and then provides the plan to the administrator.

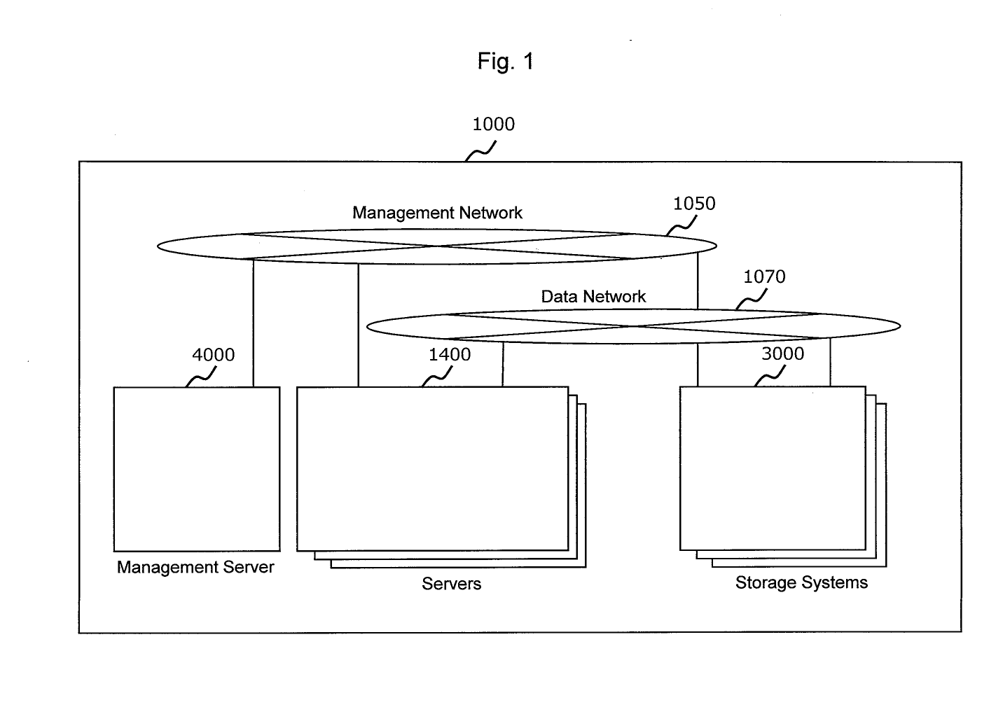

FIG. 1 illustrates an example of a hardware configuration of a system in which the method and apparatus of the invention may be applied. The system 1000 includes a management server 4000, servers 1400, and storage systems 3000. The servers 1400 and storage systems 3000 are connected via a Data Network 1070. The network is usually a WAN (Wide Area Network), but it is not limited to this. The management server 4000, servers 1400, and storage systems 3000 are connected via a management network 1050. The network is usually a WAN, but it is not limited to this. In the embodiment shown, the management network and data network are separate, but the invention is not limited to this. In the embodiment shown, the management server 4000 and servers 1400 are separate, but the invention is not limited to this. For example, any server can host a management server. In the embodiment shown, the servers 1400 and storage systems 3000 are separate, but the invention is not limited to this. For example, server and storage system can be combined into one system.

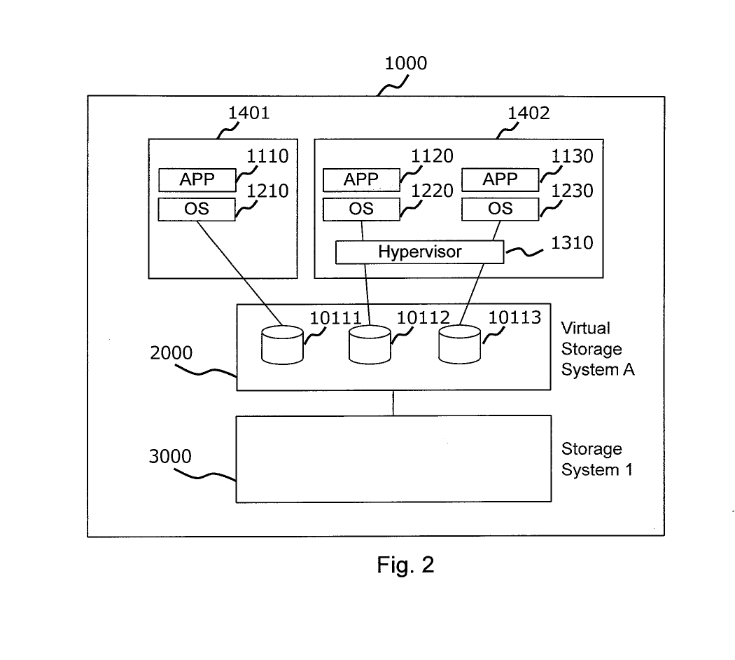

FIG. 2 shows a logical configuration of the system 1000 of FIG. 1. Application 1110 and OS (Operating System) 1210 run on the server 1401. Applications 1120, 1130, and OS 1220, 1230 run on the hypervisor 1310. The hypervisor 1310 runs on the server 1402. Server 1401 uses volume 10111. Server 1402 uses volumes 10112 and 10113. Volumes 10111, 10112, and 10113 are provisioned from a virtual storage system A 2000. Storage system 1 3000 is the physical storage system.

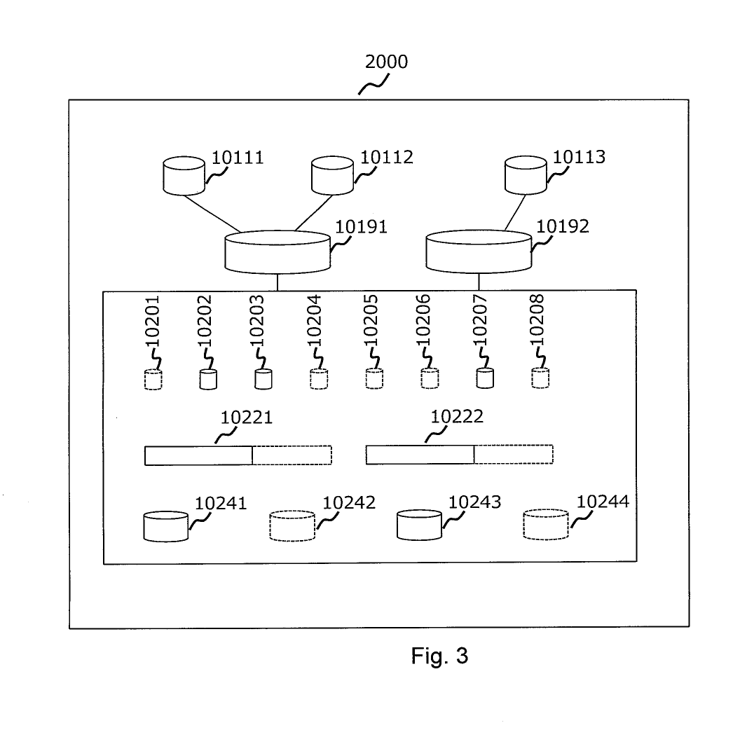

FIG. 3 shows an example of the virtual storage system 2000. Volumes 10111 and 10112 are provisioned from a storage pool 10191. Volume 10113 is provisioned from a storage pool 10192. The storage pools 10191 and 10192 are created on the virtual storage system 2000. The virtual storage system 2000 contains port resources 10201, 10202, 10203, 10204, 10205, 10206, 10207, and 10208, cache resources 10221 and 10222, and capacity resources 10241, 10242, 10243, and 10244. These are referred to as other types of virtual elements, i.e., other than virtual volume as one type of virtual elements. Solid line resources such as 10202 are in use. Dotted line resources such as 10201 are not in use.

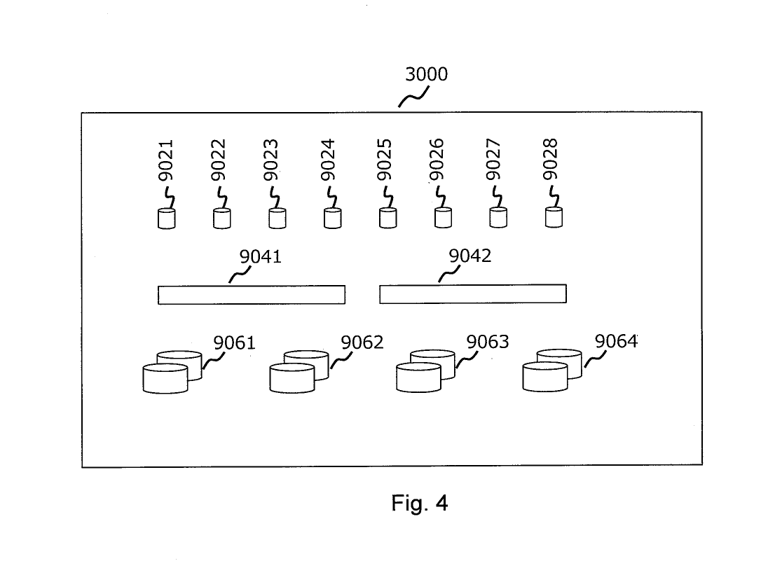

FIG. 4 shows an example of the physical storage system 3000. The physical storage system 3000 includes port resources 9021, 9022, 9023, 9024, 9025, 9026, 9027, and 9028, cache resources 9041 and 9042, and capacity resources 9061, 9062, 9063, and 9064. The capacity resource is usually an array group, but it is not limited to this.

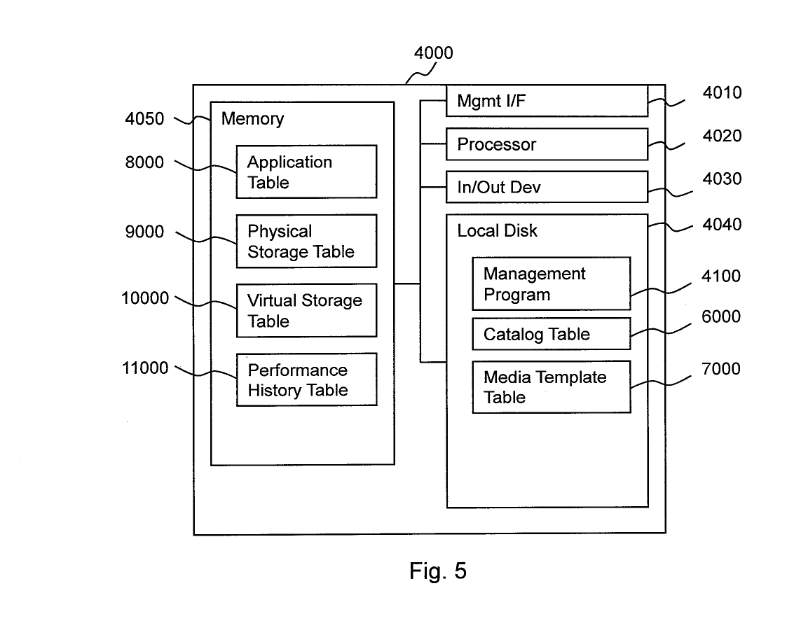

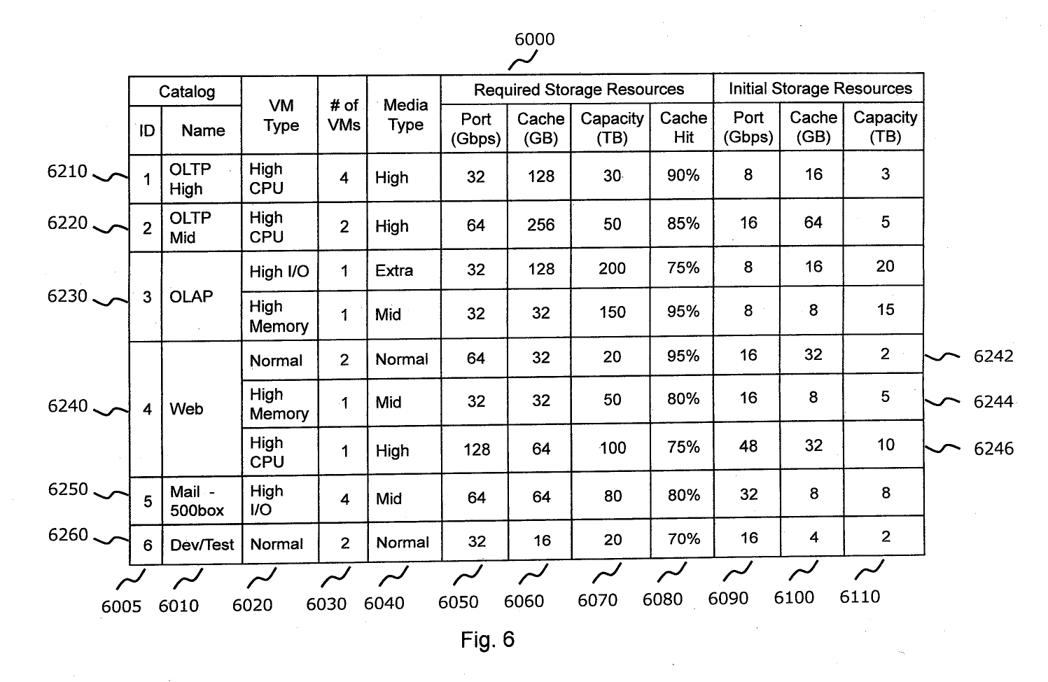

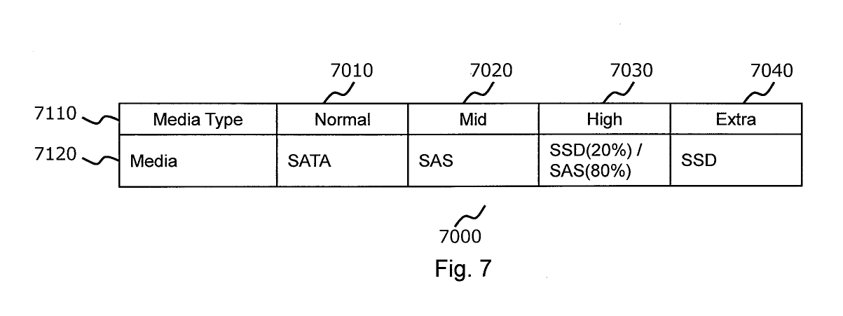

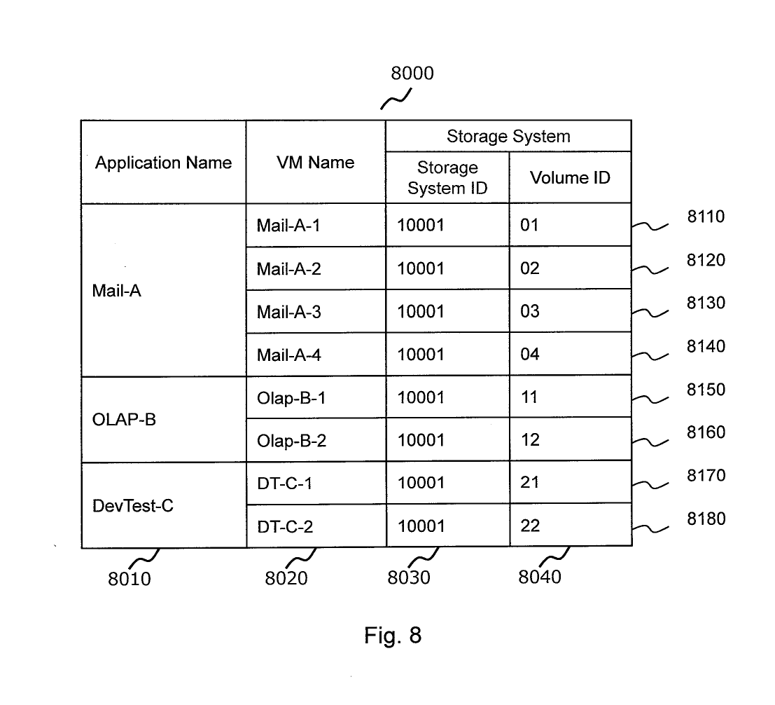

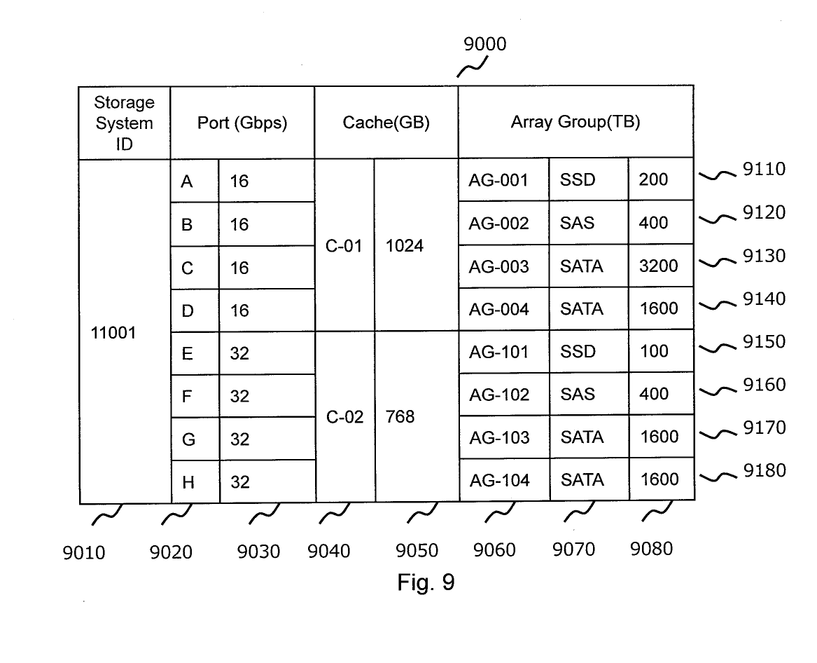

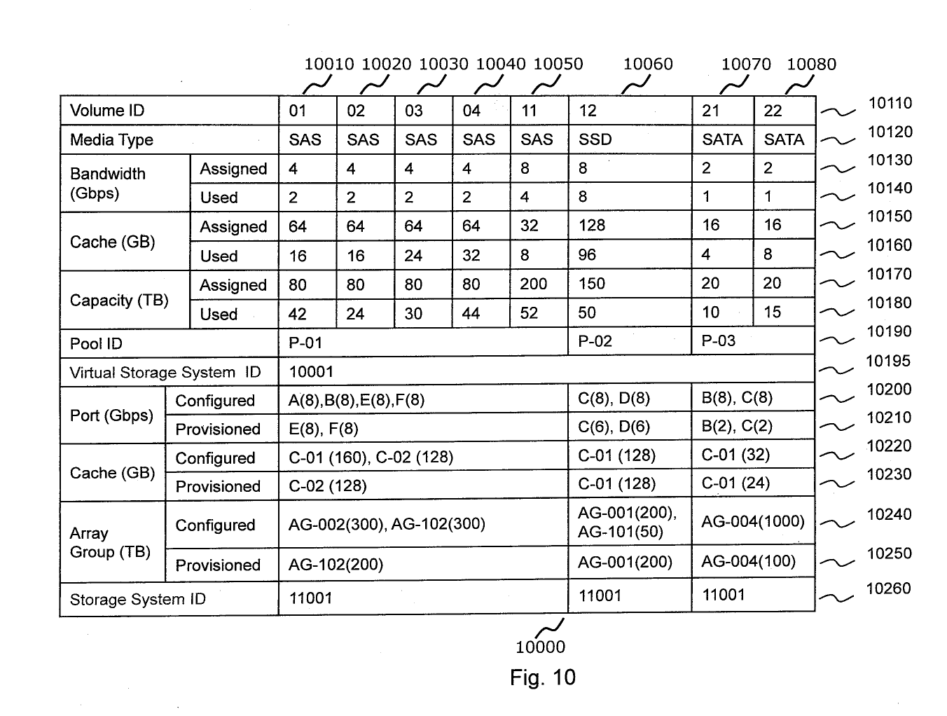

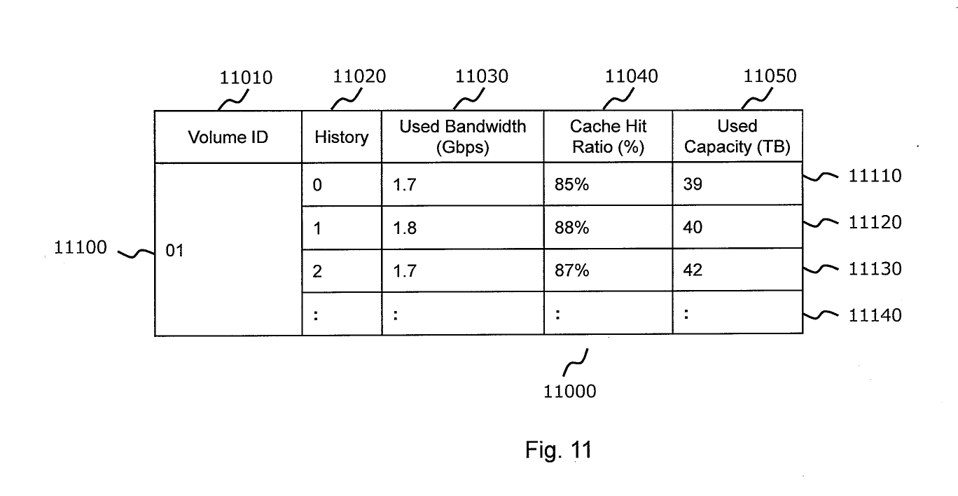

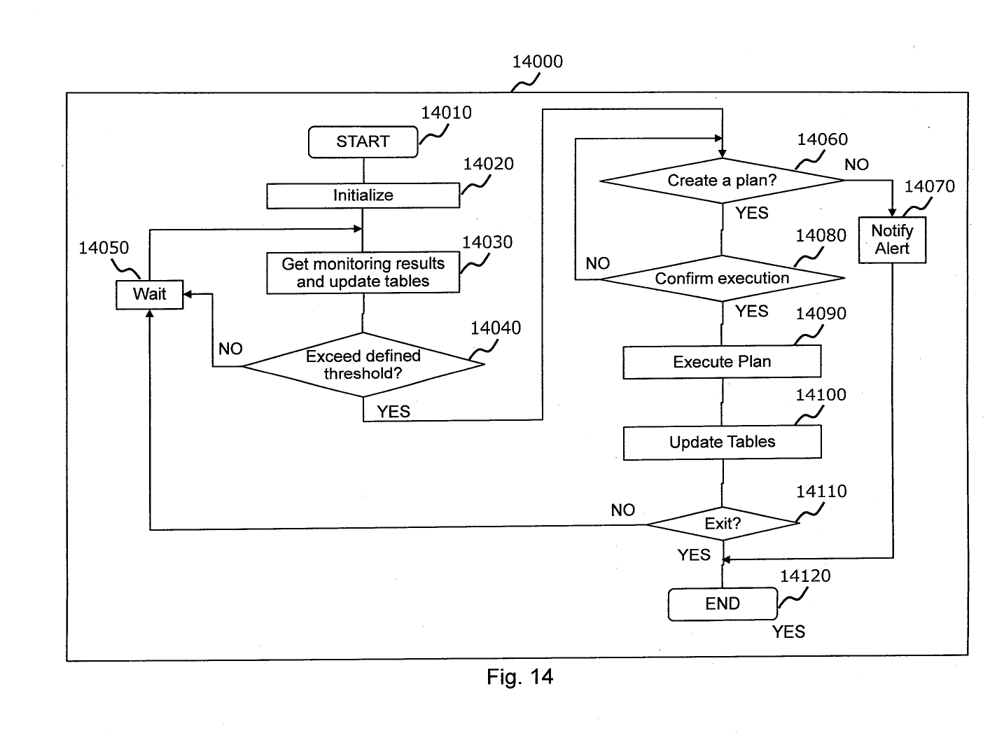

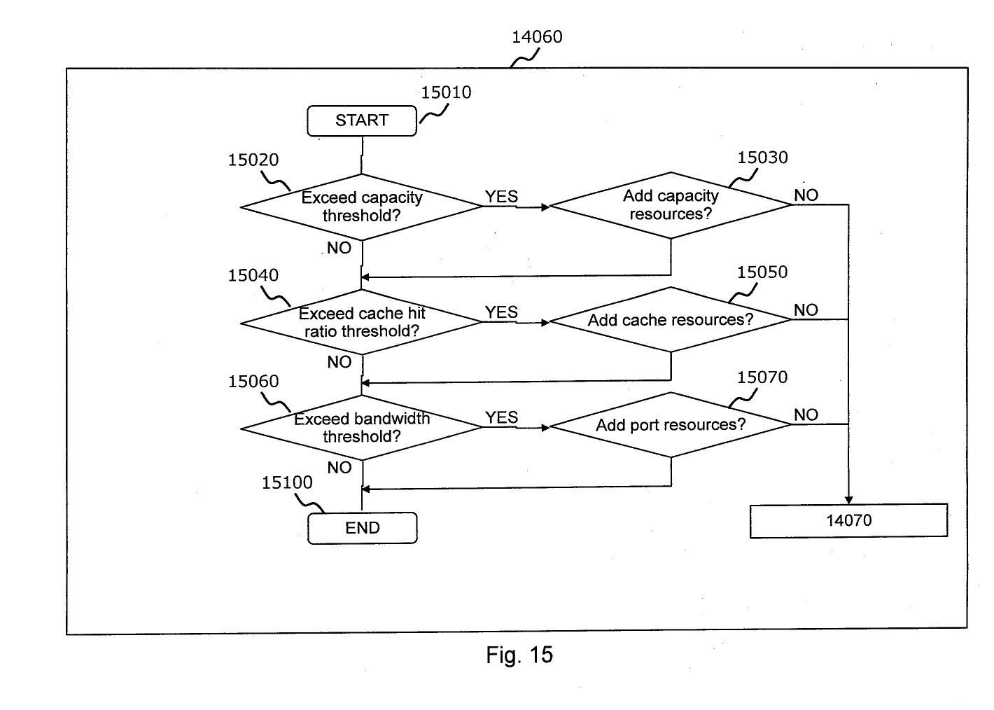

FIG. 5 shows an example of the management server 4000 in the system 1000 of FIG. 1. Management interface 4010 is an interface to the management network 1050. Input and output device 4030 is a user interface such as monitor, keyboard, and mouse. Local Disk 4040 contains management program 4100, catalog table 6000, and media template table 7000. The management program 4100 is loaded to a memory 4050 and executed by a processor 4020. The procedure of the management program 4100 is disclosed later using FIG. 14 and FIG. 15. The catalog table 6000 (FIG. 6) and media template table 7000 (FIG. 7) are loaded to the memory 4050 and used by the management program 4100. The memory 4050 contains application table 8000 (FIG. 8), physical storage table 9000 (FIG. 9), virtual storage table 10000 (FIG. 10), and performance history table 11000 (FIG. 11).

FIG. 6 shows an example of the catalog table 6000. This catalog is referred to when the administrator provisions IT resources by using a self-service portal. This table is loaded from the local disk 4040 to the memory 4050 of the management server 4000. Column 6005 shows the identification of the catalog. Column 6010 shows the name of the catalog. Columns 6020 and 6030 are the required specification of the VM resources for each catalog. Column 6020 shows the type of the virtual machine (VM). Column 6030 shows the number of VMs. Columns 6040 to 6110 are the specification of the storage resources for each catalog. Column 6040 shows the type of the storage media. Actual media is decided by looking up the media template table 7000. Column 6050, 6060, and 6070 are the resources which are assigned finally for each catalog. Column 6050 shows the full bandwidth of the storage port for each catalog. Column 6060 shows the full capacity of the storage cache for each catalog. Column 6070 shows the full capacity of the storage volume for each catalog. Column 6080 shows the minimum cache hit ratio for each catalog. Each application must exceed this cache hit ratio. Column 6090, 6100, and 6110 are the resources which are assigned at the beginning for each catalog. Column 6090 shows the initial bandwidth of the storage port for each catalog. Column 6100 shows the initial capacity of the storage cache for each catalog. Column 6110 shows the initial capacity of the storage volume for each catalog.

Each row (6210 to 6260) shows the required specification for each catalog. For example, row 6240 shows the catalog of the Web application. This catalog has three types of VMs: two VMs of normal VM 6242, one high memory VM 6244, and one high CPU VM 6246, a total of 4 VMs. For example, ‘High memory’ VM 6244 requires ‘Mid’ storage. The full specification of this volume is: Port=32 Gbps, Cache=32 GB, Capacity=50 TB and the minimum cache hit ratio is 80%. The initial assignment for this volume is: Port=16 Gbps, Cache=8 GB, Capacity=5 TB.

FIG. 7 shows an example of the media template table 7000. This template describes the resource configuration of each media type 6040 in the catalog table 6000. This table is loaded from the local disk 4040 to the memory 4050 of the management server 4000. Row 7110 shows the media type 6040. Row 7120 shows the media. Each column (7010 to 7040) shows the resource configuration of each media type. For example, column 7010 shows the configuration of the ‘Normal’ media. This type of media consists of SATA HDD.

FIG. 8 shows an example of the application table 8000. This table shows each application instance. This table is created in the memory 4050 by the management program 4100. Column 8010 shows the application name. Column 8020 shows the VM name. Column 8030 shows the identification of the storage system. Column 8040 shows the identification of the volume. Each row (8110 to 8180) shows the volume of each application. For example, row 8110 shows the volume 01 of the storage system 10001 is used by the virtual machine ‘Mail-A−1’, and this virtual machine is part of application ‘Mail-A’.

FIG. 9 shows an example of the physical storage table 9000. This table describes the resource configuration of the physical storage system. This table is created in the memory 4050 by the management program 4100. Column 9010 shows the identification of the storage system. Column 9020 shows the identification of the storage port. Column 9030 shows the bandwidth of the storage port. Column 9040 shows the identification of the storage cache. Column 9050 shows the capacity of the cache. Column 9060 shows the identification of the array group. Column 9070 shows the media type of the array group. Column 9080 shows the capacity of the array group. Each row (9110 to 9180) shows the resource configuration of physical storage system. For example, row 9110, row 9120, row 9130, and row 9140 show that four ports (A, B, C and D) and four array groups (AG-001, AG-002, AG-003 and AG004) share a cache ‘C-01’.

FIG. 10 shows an example of the virtual storage table 10000 according to the first embodiment. This table is created in the memory 4050 by the management program 4100. Row 10110 shows the identification of the volume. Row 10120 shows the media type. Row 10130 shows the assigned bandwidth. This volume can use this bandwidth at a maximum. Row 10140 shows the used bandwidth. This value shows the current bandwidth of this volume. Row 10150 shows the assigned cache. This volume can use this cache at a maximum. Row 10160 shows the used cache. This value shows the current used cache of this volume. Row 10170 shows the assigned capacity. This volume can use this capacity at a maximum. Row 10180 shows the used capacity. This value shows the current capacity of this volume. Row 10190 shows the identification of the storage pool. Row 10195 shows the identification of the virtual storage system. Row 10200 shows the configured ports and the bandwidth for each of the configured ports in the storage pool. For example, 8 Gbps of port A, B, E and F are configured in the pool P-01, but all of these ports are not provisioned yet. Row 10210 shows the provisioned ports. For example, 8 Gbps of port E and F are provisioned. Row 10220 shows the configured cache in the storage pool. For example, 160 GB of C-01 and 128 GB of C-02 are configured in the pool P-01, but all of the cache resources are not provisioned yet. Row 10230 shows the provisioned cache. For example, 128 GB of C-02 is provisioned. Row 10240 shows the configured capacity in the storage pool. For example, 300 TB of AG-002 and 300 TB of AG-102 are configured in the pool P-01, but all of the capacity resources are not provisioned yet. Row 10250 shows the provisioned capacity. For example, 200 TB of AG-102 is provisioned. Row 10260 shows the identification of the physical storage system.

Each column (10010 to 10080) shows the resource configuration of each volume. For example, column 10010 shows the resource configuration of the volume 01. Media type of the volume 01 is SAS. Assigned bandwidth of the volume 01 is 4 Gbps and used bandwidth is 2 Gbps. Assigned cache of the volume 01 is 64 GB and used cache is 16 GB. Assigned capacity of the volume 01 is 80 TB and used capacity is 42 TB. Volume 01 uses storage pool P-01.

FIG. 11 shows an example of the performance history table 11000. Column 11010 shows the identification of the volume. Column 11020 shows the identification (history) of each entry, but it is not limited to this. For example, this can be a time stamp of each record. Column 11030 shows the used bandwidth of this volume. Column 11040 shows the cache hit ratio of this volume. Column 11050 shows the used capacity of this volume. Each row (rows 11110 to 11140 in row group 11100) shows the resource utilization of the specified period of this volume. For example, row 11120 shows that volume 01 uses 1.8 Gbps bandwidth and 40 TB capacity, and the cache hit ratio is 88% at period ‘1’. When the management program 4100 gets the monitoring results in step 14030 of flow diagram 14000 (FIG. 14), a new row is added, but the invention is not limited to this. For example, when the new row is added, the oldest entry can be deleted to save the memory space.

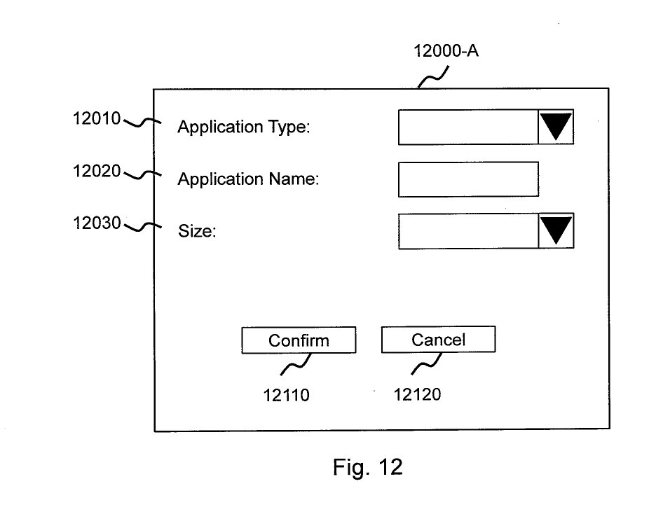

FIG. 12 shows an example of a Provisioning GUI (Graphical User Interface) 12000-A of the self-service portal. This GUI is used by the administrator to provision storage resources. The administrator selects application type 12010, such as ‘Mail-500box’. Candidates are displayed based on the catalog name 6010 of the catalog table 6000. Then, the administrator inputs an application name 12020, such as ‘Mail-A’. Then, the administrator selects the size of the application 12030. For example, a unit of the mail application is 500 boxes. Therefore, the administrator can select multiple numbers of 500. If the ‘Cancel’ button 12120 is pressed, the management program 4100 cancels the provisioning process. If the ‘Confirm’ button 12110 is pressed, the management program 4100 displays the confirmation GUI 12000-B.

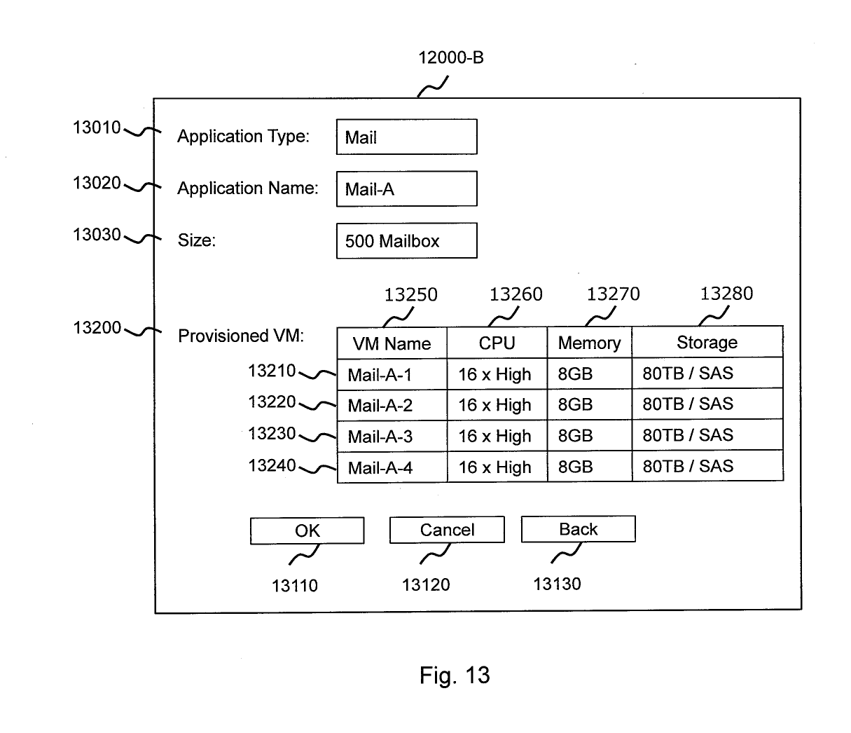

FIG. 13 shows an example of a confirmation GUI 12000-B of the self-service portal. This GUI is displayed when the application administrator presses the ‘Confirm’ button 12110 of the provisioning GUI 12000-A of the self-service portal. Field 13010 is the application type. Field 13020 is the application name. Field 13030 is the size of the application. Field 13200 is the information of the provisioned VM. Column 13250 is the name of the VM. This name is created from the application name 13020 by the management program 4100. Column 13260 is the number and type of the CPU. Column 13270 is the capacity of the memory. Column 13280 is the capacity and type of the media. Each row (13210 to 13240) shows the configuration of each VM. For example, row 13210 shows the configuration of the Mail-A−1. This VM uses 16 of High CPU, 8 GB memory, and 80 TB of SAS media. If the ‘Cancel’ button 13120 is pressed, the management program 4100 cancels the provisioning process. If the ‘Back’ button 13130 is pressed, the management program 4100 redisplays the provisioning GUI 12000-A of the self-service portal. If the ‘OK’ button 13110 is pressed, the management program 4100 executes the following procedure. First, the program checks whether any storage pool on the virtual storage system which can host the requested volume(s) exists by using virtual storage table 10000. If the management server 4100 cannot provision the requested volume(s), the management program 4100 notifies the administrator with an error. If the management server 4100 can provision the requested volume(s) on any virtual storage system, it provisions storage resources on selected virtual storage system. The program adds a new row to the virtual storage table 10000.

FIG. 14 shows an example of a flow diagram illustrating a process of the management program 4100 of the management server 4000. The program starts at step 14010. In step 14020 to initialize, the management program 4100 creates the application table 8000, physical storage table 9000, virtual storage table 10000, and performance history table 11000 in the memory 4050. The management program 4100 loads the catalog table 6000 and media template table 7000 from local disk 4040 to the memory 4050 in the management server 4000. Then, it sets the threshold. For example, the threshold is set to 95%, but the value is not limited to this. For example, different thresholds can be set for bandwidth, capacity, and cache. This value is stored in the memory 4050 of the management server 4000. Then the virtual storage system is created by the administrator. The administrator configures port, cache, and capacity of the virtual storage system and its pool. This result is reflected in the virtual storage table 10000.

In step 14030, the program gets monitoring results from each volume, and then updates the performance history table 11000. If a new physical storage system is added, the management program 4100 updates the physical storage table 9000. If a new application is deployed by the self-service portal GUI 12000, the management program 4100 updates the application table 8000. In step 14040, the program judge whether the monitored value exceeds the threshold. If the monitored value exceeds the threshold which is set when the application is deployed, the program goes to step 14060; otherwise, it goes to step 14050.

Port and capacity are judged as follows. Throughput 11030 and used capacity 11050 of the latest entry of the performance history table 11000 are reflected in the used bandwidth 10140 and used capacity 10180 of the virtual storage table 10000. For example, this result becomes part of the virtual storage table 10000. Total used capacity of the pool P-01 is 192 TB. This value exceeds the 95% of provisioned capacity 200 TB. Therefore, the program goes to step 14060. As for the cache, all the capacity that is prepared is consumed. Therefore, the cache hit ratio 11040 in the performance history table 11000 is used to judge. For example, if the actual value of the cache hit ratio 11040 falls below the target value of the cache hit ratio 6080, the program goes to step 14060, but the invention is not limited to this. In step 14050, the program waits for a while, and then goes to Step 14030.

In step 14060 to create a plan, because of resource shortage, the program tries to create a resource addition plan. The management program 4100 focuses on the resource which exceeds the threshold. Resource type is one of the port, cache, or capacity. If all the assigned resource is used, the program goes to step 14070 because the management program 4100 cannot assign any more resource. For example, for cache resource of volume 01, 64 GB of cache is assigned. It is assumed that 64 GB cache is already used. In this case, the management program 4100 cannot prorate additional cache. Or, if all the resources which are configured on the virtual storage system are provisioned, the program goes to step 14070 because the management server cannot provision additional resources. For example, for cache resource of pool P-01, 288 GB of cache is configured. It is assumed that 288 GB cache is already provisioned. In this case, the management program 4100 cannot provision additional cache. On the other hand, if resource is otherwise available, the management program 4100 provisions a certain amount of resources and provides it to the volume. In this description, the certain amount is 10% of the assigned resources for cache, port, and capacity of volume, but a different percentage may be selected. For example, the assigned cache of the volume 01 is 64 GB and the used cache is 16 GB. If there is a cache shortage, 6.4 GB of cache is added, but the invention is not limited to this. If an effective plan is created, the program goes to step 14080; otherwise, it goes to step 14070. In step 14070 for alert, because the management program 4100 cannot create an effective plan any more, it notifies alert to the administrator. The program then ends at step 14120.

In step 14080 to confirm execution, the program provides the created plan to the administrator. The administrator can select immediate execution or scheduled execution. The administrator does not necessarily have to execute the plan. If scheduled execution is specified, the program registers the plan to the scheduler. If the application administrator wants to execute the provided plan, the program goes to step 14090; otherwise, it goes to 14060.

In step 14090, the program executes the created plan. Based on the executed plan, the configuration will change. Therefore, the virtual storage table 10000 is updated in step 14100. In step 14110, the program checks whether there is termination indication by the user. If termination indication exists, the program ends at step 14120; otherwise, it goes to step 14050 to wait.

FIG. 15 shows an example of a flow diagram illustrating a process to create a plan under step 14060 of FIG. 14 by the management program 4100 of the management server 4000. The program starts at step 15010. In step 15020, the management program 4100 checks whether the capacity threshold is exceeded or not. If the capacity threshold is exceeded, the program goes to step 15030; otherwise, it goes to step 15040. In step 15030, the management program 4100 tries to add capacity resources to the volume. If all the assigned capacity is used, the program goes to step 14070 because the management program 4100 cannot assign capacity to this volume any more. For example, for capacity resource of volume 01, 80 TB of capacity is assigned. It is assumed that 80 TB capacity is already used. In this case, the management program 4100 cannot prorate additional capacity. Or, if all the resources which are configured on the storage pool of the virtual storage system are provisioned, the program goes to step 14070 of FIG. 14 because management server cannot provision additional resources. For example, for array group resource of pool P-01, 300 TB of AG-002 and 300 TB of AG-102 are configured. It is assumed that 600 TB of capacity is already provisioned. In this case, the management program 4100 cannot provision additional array group. Otherwise, the management program 4100 provisions a certain amount of resources and provides it to the volume. This amount is 10% of the assigned resources. For example, assigned capacity of the volume 01 is 80 TB and used capacity is 16 TB. If the capacity has a shortage, 8 TB of capacity is added, but the invention is not limited to this. If 8 TB of storage capacity cannot be assigned from pool P-01, the program goes to step 14070.

If the management program 4100 can assign capacity resources, the program goes to step 15040. In step 15040, the management program 4100 checks whether the cache hit ratio threshold is exceeded or not. If the cache hit ratio threshold is exceeded, the program goes to step 15050; otherwise, it goes to step 15060.

In step 15050, the management program 4100 tries to add cache resources to the volume. If all the assigned cache is used, the program goes to step 14070 of FIG. 14 because the management program 4100 cannot assign cache to this volume any more. For example, for cache resource of volume 01, 64 GB of cache is assigned. It is assumed that 64 GB cache is already used. In this case, the management program 4100 cannot prorate additional cache. Or, if all the resources which are configured on the storage pool of the virtual storage system are provisioned, the program goes to step 14070 of FIG. 14 because the management server cannot provision additional resources. For example, for the cache resource of pool P-01, 160 GB of C-01 and 128 GB of C-02 are configured. It is assumed that 288 GB of cache is already provisioned. In this case, the management program 4100 cannot provision additional cache. Otherwise, the management program 4100 provisions a certain amount of resources and provides it to the volume. This amount is 10% of the assigned resources. For example, assigned cache of the volume 01 is 64 GB and used cache is 16 GB. If the cache has a shortage, 6.4 GB of cache is added, but the invention is not limited to this. If 6.4 GB of cache cannot be assigned from pool P-01, the program goes to step 14070 of FIG. 14. If the management program 4100 can assign cache resources, it goes to step 15060.

In step 15060, the management program 4100 checks whether the port bandwidth threshold is exceeded or not. If the port bandwidth threshold is exceeded, the program goes to step 15070; otherwise it goes to step 15100 and the process ends.

In step 15070, the management program 4100 tries to add port resources to the volume. If all the assigned port bandwidth is used, the program goes to step 14070 because the management program 4100 cannot assign port bandwidth to this volume any more. For example, for port bandwidth resource of volume 01, 4 Gbps of port bandwidth is assigned. It is assumed that 4 Gbps port bandwidth is already used. In this case, the management program 4100 cannot prorate additional port bandwidth. Or, if all the resources which are configured on the storage pool of the virtual storage system are provisioned, the program goes to step 14070 because the management server cannot provision additional resources. For example, for port bandwidth resource of pool P-01, 8 Gbps of port A, 8 Gbps of port B, 8 Gbps of port C, and 8 Gbps of port D are configured. It is assumed that 32 Gbps of port bandwidth is already provisioned. In this case, the management program 4100 cannot provision additional port bandwidth. Otherwise, the management program 4100 provisions a certain amount of resources and provide it to the volume. This amount is 10% of the assigned resources. For example, assigned port bandwidth of the volume 01 is 4 Gbps and used port bandwidth is 2 Gbps. If the port bandwidth has a shortage, 0.4 Gbps of port bandwidth is added, but the invention is not limited to this. If 0.4 GB of port bandwidth cannot be assigned from the pool P-01, the program goes to step 14070. If the management program 4100 can assign port bandwidth resources, the program ends at step 15100.

In this embodiment, the management program monitors resource usage of each volume. The management program monitors the infrastructure, and if it discovers the resource shortage of the volume, the management program creates the plan, and then provides it to the administrator. This realizes the virtual storage system which is not conscious of physical configuration. Combination of this technique and history data managed by the performance monitoring software realizes the thin provisioning of virtual storage system. The target of this embodiment is block storage system, but it is not limited to this. For example, if the target storage system is file storage such as NFS/CIFS, it is possible to apply the approach of this invention.

### Embodiment 2

In Embodiment 1, the ratio of physical storage system to virtual storage system is 1:1, but the invention is not limited to this. For example, in the case where the ratio of physical storage system to virtual storage system is N:M, it is possible to apply this invention. In such cases, one virtual storage pool can consists of array groups of one physical storage system, but the invention is not limited to this.

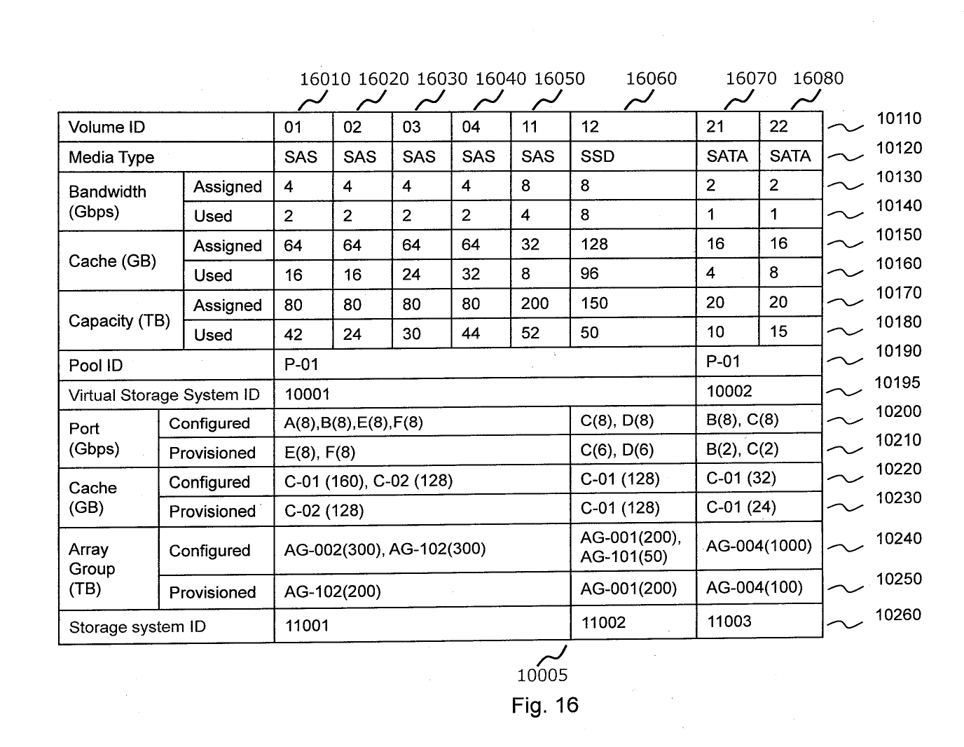

FIG. 16 shows an example of the virtual storage table 10005 according to the second embodiment. This table is almost the same as the virtual storage table 10000 of the first embodiment shown in FIG. 10. Only the differences are described. In FIG. 16, the system has three physical storage systems 11001, 11002, 11003 and two virtual storage systems 10001, 10002 (instead of one each in FIG. 10). Virtual storage system 10001 consists of two physical storage systems 11001 and 11002. In this case, resources from two physical storage systems are merged in one storage pool P-01 in virtual storage system 10001. Therefore, one virtual volume may utilize resources of multiple physical storage systems. Virtual storage system 10002 consists of one physical storage system 11003

Referring to FIG. 15 and applying the process to create a plan under step 14060 of FIG. 14 by the management program 4100 of the management server 4000 according to the second embodiment, the procedure is almost the same as that of the first embodiment. In the second embodiment, however, storage pool P-01 is configured from multiple physical storage systems 11001 and 11002. Therefore, the management program 4100 should consider the connectivity among the resources. Only the differences from the first embodiment are explained.

In step 15030, the management program 4100 tries to add capacity resources to the storage pool. If all the assigned capacity is used, the program goes to step 14070 because the management program 4100 cannot assign capacity to this volume any more. For example, for capacity resource of volume 12, 150 TB of capacity is assigned. It is assumed that 150 TB capacity is already used. In this case, the management program 4100 cannot prorate additional capacity. Or, if all the resources which are configured on the virtual storage system are provisioned, the program goes to step 14070 because the management server cannot provision additional resources. For example, for array group resource of pool P-01, 300 TB of AG-002, 300 TB of AG-102 of storage system 11001 and 200 TB of AG-001 and 50 TB of AG-101 of storage system 11002 are configured, as seen in FIG. 16. If the volume 12 exceeds the threshold, however, all the array groups cannot be used because volume 12 uses resources of physical storage system 11002. Therefore, the management program 4100 only can assign the resources from AG-001 or AG101 of storage system 11002. It is assumed that 200 TB of AG-001 and 50 TB of AG-101 are already provisioned. In this case, the management program 4100 cannot provision additional array group. Otherwise, the management program 4100 provisions a certain amount of resources and provides it to the volume. This amount is 10% of the assigned resources. For example, assigned capacity of the volume 12 is 150 TB and used capacity is 50 TB. If the capacity has a shortage, 15 TB of capacity is added, but the invention is not limited to this. If 15 TB of storage capacity cannot be assigned from pool P-01, the program goes to step 14070. If the management program 4100 can assign capacity resources, the program goes to step 15040.

In step 15040, the management program 4100 checks whether the cache hit ratio threshold is exceeded or not. If the capacity threshold is exceeded, the program goes to step 15050; otherwise, it goes to step 15060.

In step 15050, the management program 4100 tries to add cache resources to the storage pool. If all the assigned cache is used, the program goes to step 14070 because the management program 4100 cannot assign cache to this volume any more. For example, for cache resource of volume 12, 128 GB of cache is assigned. It is assumed that 128 GB cache is already used. In this case, the management program 4100 cannot prorate additional cache. Or, if all the resources which are configured on the storage pool of the virtual storage system are provisioned, the program goes to step 14070 because the management server cannot provision additional resources. For example, for cache resource of pool P-01, 160 GB of C-01 and 128 GB of C-02 of storage system 11001 and 128 GB of C-01 of storage system 11002 are configured. If the volume 12 exceeds the threshold, however, all the cache cannot be used because volume 12 uses resources of physical storage system 11002. Therefore, the management program 4100 only can assign the resources from C-01 of storage system 11002. It is assumed that 128 GB of C-01 are already provisioned. In this case, the management program 4100 cannot provision additional cache. Otherwise, the management program 4100 provisions a certain amount of resources and provides it to the volume. This amount is 10% of the assigned resources. For example, assigned cache of the volume 12 is 128 GB and used cache is 96 GB. If the cache has a shortage, 12.8 GB of cache is added, but the invention is not limited to this. If 12.8 GB of cache cannot be assigned from pool P-01, the program goes to step 14070. If the management program 4100 can assign cache resources, the program goes to step 15060.

In step 15060, the management program 4100 checks whether the port bandwidth threshold is exceeded or not. If the port bandwidth threshold is exceeded, the program goes to step 15070; otherwise, it goes to step 15100 and the process ends.

In step 15070, the management program 4100 tries to add port resources to the volume. If all the assigned port bandwidth is used, the program goes to step 14070 because the management program 4100 cannot assign port bandwidth to this volume any more. For example, for port bandwidth resource of volume 12, 8 Gbps of port bandwidth is assigned. It is assumed that 8 Gbps port bandwidth is already used. In this case, the management program 4100 cannot prorate additional port bandwidth. Or, if all the resources which are configured on the storage pool of the virtual storage system are provisioned, the program goes to step 14070 because the management server cannot provision additional resources. For example, for port bandwidth resource of pool P-01 of the virtual storage system 10001, 8 Gbps of port A, 8 Gbps of port B, 8 Gbps of port E and 8 Gbps of port F of storage system 11001 and 8 Gbps of port C and 8 Gbps of port D of storage system 11002 are configured. If the volume 12 exceeds the threshold, however, all the port bandwidth cannot be used because volume 12 uses resources of physical storage system 11002. Therefore, the management program 4100 only can assign the resources from 8 Gbps of port C and 8 Gbps of port D of storage system 11002. It is assumed that 8 Gbps of port C and 8 Gbps of port D of storage system 11002 are already provisioned. In this case, the management program 4100 cannot provision additional cache. Otherwise, the management program 4100 provisions a certain amount of resources and provide it to the volume. This amount is 10% of the assigned resources. For example, assigned port bandwidth of the volume 12 is 8 Gbps and used port bandwidth is 6 Gbps. If the port bandwidth has a shortage, 0.8 Gbps of port bandwidth is added, but the invention is not limited to this. If 0.8 GB of port bandwidth cannot be assigned from pool P-01, the program goes to step 14070. If the management program 4100 can assign port bandwidth resources, the program goes to step 15100 and the process ends.

The second embodiment realizes thin provisioning of the virtual storage system even if the storage pool is configured from multiple physical storage systems by taking account of the connectivity of the physical storage systems.

Of course, the system configuration illustrated in FIG. 1 is purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for thin provisioning of virtual storage systems. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A first computer comprising:
a memory; and
a processor being operable to manage a virtual storage system, formed by one or more physical storage systems, to be provided to a plurality of second computers, the virtual storage system including a plurality of virtual volumes and a plurality of other types of virtual elements;
wherein the processor is operable to monitor performance of the plurality of virtual volumes, and to calculate amounts of the plurality of other types of virtual elements to be additionally assigned to the virtual storage system, based on the monitored performance of the plurality of virtual volumes, during operation of the one or more physical storage systems involving accesses from the plurality of second computers to the virtual storage system.

2. The first computer according to claim 1,
wherein the plurality of other types of virtual elements comprise at least one of virtual port, virtual cache, or virtual storage area.

3. The first computer according to claim 2,
wherein for virtual port, the processor is operable to calculate an amount of virtual port to be additionally assigned to the virtual storage system when a bandwidth of the virtual port exceeds a preset bandwidth threshold based on the monitored performance;
wherein for virtual cache, the processor is operable to calculate an amount of virtual cache to be additionally assigned to the virtual storage system when a cache hit ratio of the virtual port exceeds a preset cache hit ratio threshold based on the monitored performance; and
wherein for virtual storage area, the processor is operable to calculate an amount of virtual storage area to be additionally assigned to the virtual storage system when a capacity of the virtual storage area exceeds a preset capacity threshold based on the monitored performance.

4. The first computer according to claim 1,
wherein the processor is operable to create a virtual storage table showing, for each virtual volume, amounts of the other types of virtual elements assigned, amounts of the other types of virtual elements used, storage pool identification of a storage pool, physical storage resources which are configured and physical storage resources which are provisioned in the storage pool to provide the other types of virtual elements to the virtual storage system; and
wherein the virtual storage table is used to calculate the amounts of the plurality of other types of virtual elements to be additionally assigned to the virtual storage system.

5. The first computer according to claim 4,
wherein the virtual storage system is formed by one physical storage system; and
wherein physical storage resources are provisioned from one storage pool corresponding to the one physical storage system.

6. The first computer according to claim 4,
wherein the virtual storage system is formed by a plurality of physical storage systems;
wherein physical storage resources are provisioned from a plurality of storage pools corresponding to the plurality of physical storage systems; and
wherein the virtual storage table is used to identify, for a given virtual volume, the corresponding storage pool from which storage resources are to be used to provide the calculated amounts of the plurality of other types of virtual elements to be additionally assigned to the virtual storage system.

7. A system comprising:
a plurality of second computers;
a plurality of physical storage systems; and
a first computer which includes a memory and a processor being operable to manage a virtual storage system, formed by one or more physical storage systems of the plurality of physical storage systems, to be provided to the plurality of second computers, the virtual storage system including a plurality of virtual volumes and a plurality of other types of virtual elements;
wherein the processor is operable to monitor performance of the plurality of virtual volumes, and to perform thin provisioning of the plurality of other types of virtual elements to the virtual storage system, based on the monitored performance of the plurality of virtual volumes, during operation of the one or more physical storage systems involving accesses from the plurality of second computers to the virtual storage system.

8. The system according to claim 7,
wherein performing thin provisioning comprises calculating amounts of the plurality of other types of virtual elements to be additionally assigned to the virtual storage system.

9. The system according to claim 8,
wherein the plurality of other types of virtual elements comprise at least one of virtual port, virtual cache, or virtual storage area.

10. The system according to claim 9,
wherein for virtual port, the processor is operable to calculate an amount of virtual port to be additionally assigned to the virtual storage system when a bandwidth of the virtual port exceeds a preset bandwidth threshold based on the monitored performance;
wherein for virtual cache, the processor is operable to calculate an amount of virtual cache to be additionally assigned to the virtual storage system when a cache hit ratio of the virtual port exceeds a preset cache hit ratio threshold based on the monitored performance; and
wherein for virtual storage area, the processor is operable to calculate an amount of virtual storage area to be additionally assigned to the virtual storage system when a capacity of the virtual storage area exceeds a preset capacity threshold based on the monitored performance.

11. The system according to claim 8,
wherein the processor is operable to create a virtual storage table showing, for each virtual volume, amounts of the other types of virtual elements assigned, amounts of the other types of virtual elements used, storage pool identification of a storage pool, physical storage resources which are configured and physical storage resources which are provisioned in the storage pool to provide the other types of virtual elements to the virtual storage system; and
wherein the virtual storage table is used to calculate the amounts of the plurality of other types of virtual elements to be additionally assigned to the virtual storage system.

12. The system according to claim 11,
wherein the virtual storage system is formed by one physical storage system; and
wherein physical storage resources are provisioned from one storage pool corresponding to the one physical storage system.

13. The system according to claim 11,
wherein the virtual storage system is formed by a plurality of physical storage systems;
wherein physical storage resources are provisioned from a plurality of storage pools corresponding to the plurality of physical storage systems; and
wherein the virtual storage table is used to identify, for a given virtual volume, the corresponding storage pool from which storage resources are to be used to provide the calculated amounts of the plurality of other types of virtual elements to be additionally assigned to the virtual storage system.

14. A non-transitory computer-readable storage medium storing a plurality of instructions for controlling a data processor to manage a virtual storage system, formed by one or more physical storage systems, to be provided to a plurality of computers, the virtual storage system including a plurality of virtual volumes and a plurality of other types of virtual elements, the plurality of instructions comprising:
instructions that cause the data processor to monitor performance of the plurality of virtual volumes, and to calculate amounts of the plurality of other types of virtual elements to be additionally assigned to the virtual storage system, based on the monitored performance of the plurality of virtual volumes, during operation of the one or more physical storage systems involving accesses from the plurality of second computers to the virtual storage system.

15. The non-transitory computer-readable storage medium according to claim 14,
wherein the plurality of other types of virtual elements comprise at least one of virtual port, virtual cache, or virtual storage area.

16. The non-transitory computer-readable storage medium according to claim 14,
wherein for virtual port, the instructions that cause the data processor to calculate comprise instructions that cause the data processor to calculate an amount of virtual port to be additionally assigned to the virtual storage system when a bandwidth of the virtual port exceeds a preset bandwidth threshold based on the monitored performance;
wherein for virtual cache, the instructions that cause the data processor to calculate comprise instructions that cause the data processor to calculate an amount of virtual cache to be additionally assigned to the virtual storage system when a cache hit ratio of the virtual port exceeds a preset cache hit ratio threshold based on the monitored performance; and
wherein for virtual storage area, the instructions that cause the data processor to calculate comprise instructions that cause the data processor to calculate an amount of virtual storage area to be additionally assigned to the virtual storage system when a capacity of the virtual storage area exceeds a preset capacity threshold based on the monitored performance.

17. The non-transitory computer-readable storage medium according to claim 14, wherein the plurality of instructions further comprise:
instructions that cause the data processor to create a virtual storage table showing, for each virtual volume, amounts of the other types of virtual elements assigned, amounts of the other types of virtual elements used, storage pool identification of a storage pool, physical storage resources which are configured and physical storage resources which are provisioned in the storage pool to provide the other types of virtual elements to the virtual storage system; and
wherein the virtual storage table is used to calculate the amounts of the plurality of other types of virtual elements to be additionally assigned to the virtual storage system.

18. The non-transitory computer-readable storage medium according to claim 17,
wherein the virtual storage system is formed by one physical storage system; and
wherein physical storage resources are provisioned from one storage pool corresponding to the one physical storage system.

19. The non-transitory computer-readable storage medium according to claim 17,
wherein the virtual storage system is formed by a plurality of physical storage systems;
wherein physical storage resources are provisioned from a plurality of storage pools corresponding to the plurality of physical storage systems; and
wherein the virtual storage table is used to identify, for a given virtual volume, the corresponding storage pool from which storage resources are to be used to provide the calculated amounts of the plurality of other types of virtual elements to be additionally assigned to the virtual storage system.
